(19) United States
(12) Patent Application Publication
(10) Pub. No.: US 2010/0298135 A1
(43) Pub. Date: Nov. 25, 2010

(54) POROUS ALUMINUM OXIDE TEMPLATES

(75) Inventors: Martin Dionne, Quebec (CA); Sylvain Coulombe, Quebec (CA); Jean-Luc Meunier, Quebec (CA)

Correspondence Address: KLARQUIST SPARKMAN, LLP, 121 SW SALMON STREET, SUITE 1600, PORTLAND, OR, 97204, US

(73) Assignee: McGill University

(21) Appl. No.: 12/785,327

(22) Filed: May 21, 2010

Related U.S. Application Data
(60) Provisional application No. 61/180,588, filed on May 22, 2009.

(51) Int. Cl. B01J 21/04; B01J 21/18; C25D 11/04; C25D 5/44; C25D 11/18; B32B 15/04

(52) U.S. Cl. 502/439; 205/324; 205/325; 205/205; 205/201; 205/50; 977/700; 977/742; 977/762

(57) ABSTRACT

Methods for producing an anodic aluminum oxide template having a plurality of pores arranged unevenly along substantially parallel lines, embodiments of the method comprising: providing a substrate of a commercial grade aluminum alloy, the substrate having substantially parallel lines formed in at least one surface; and anodizing the commercial grade aluminum alloy substrate to form the anodic oxide template. An anodic aluminum oxide template comprising a plurality of pores arranged unevenly along substantially parallel lines extending across a surface of the anodic aluminum oxide template. An ordered carbon nanotube array comprising carbon nanotubes extending from pores of an anodic aluminum oxide template as defined above and in which the aluminum substrate is intact.

### CROSS REFERENCE TO RELATED APPLICATION

This application claims the benefit of U.S. Provisional Application No. 61/180,588, filed May 22, 2009, which is incorporated herein by reference.

### FIELD OF THE INVENTION

The invention relates generally to porous aluminum oxide templates, specifically but not exclusively to aluminum oxide templates with ordered arrays of pores, for example for nanomaterial deposition.

### BACKGROUND

Anodic aluminum oxide (AAO) templates having an ordered porous nanostructure and a high pore density are suitable for a wide range of applications including the growth of carbon nanotubes (CNT), producing highly ordered metallic nanowire and nanocapacitor arrays. Typically, the AAO templates have pores comprising elongated channels a few tens of nanometers (nm) wide separated by a few tens to a few hundreds of nm. CNT embedded in the pores of AAO templates exhibit good electron emission capabilities and have uses such as CNT-based catalyst support for hydrogen fuel cells, and as electron emitters for plasma production, field emission displays, plasma screens, gas discharge tubes, probing devices, medical and industrial X-ray sources. It is generally thought that optimized emission performance requires a CNT embedded AAO template with uniform emitter length, diameter and separating distance. Therefore, AAO templates with uniform pore dimensions and spacings are preferred.

One widely accepted method of producing such AAO templates is by a two-step anodization of high purity aluminum (99.99% purity) (Masuda, H and Fukuda, K, 1995, Science, 268, 1466). The resultant AAO templates consist of a high purity aluminum metal substrate layer, a thin barrier oxide layer and a relatively thick porous oxide layer. The pores are arranged in a hexagonal structure having a constant pore diameter and pore separation.

The two-step anodization procedure of Masuda comprises anodizing a polished sample of high purity aluminum substrate to form an oxide film. This film is selectively dissolved and removed to form an array of regular indentations on the aluminum substrate surface. A second anodization step is performed to use the pre-existing indentations to improve the ordering of the pores of the second template. The quality of the ordering in the final template increases with the duration of the first anodization step. Because the growth rate for these templates is only a few microns per hour, the first anodization step typically lasts about 10 hours to produce a suitable surface structure and the second anodization lasts from a few minutes to a few hours depending on the desired AAO thickness. The dissolution of the first template requires a 4-5% weight phosphoric acid solution whose action is as slow as the AAO growth rate during the anodization phase.

Therefore, the large scale application of this currently accepted technique for making AAO templates is limited due to the multiple anodization steps which takes time, energy and resources and so increases manufacturing costs. The method also demands the use of high purity aluminum as using a slightly lower purity aluminum substrate (99.9%) with this method has been found to produce templates with disordered or weakly ordered pores (Osika A A V, 2000, The Electrical Properties of Electrochemically Fabricated Ni Nanowires, M Sc thesis, University of Toronto, Canada).

Another limitation of this two-step anodization process is the melting point of the aluminum substrate (around 660° C.). Aluminum samples soften at 500° C. and lose their shape in the process. Even in the presence of inert atmospheres, a thin alumina crust remains present on the sample surface and creates large surface tensile stresses in the sample during cooling. As a consequence, if an as-anodized aluminum oxide template is used to grow CNT arrays, the typical CNT growth temperatures (around 700° C.) will cause the substrate to melt or soften enough to lose its initial shape and the subsequent cooling will break the AAO template. Because the AAO template is made of alumina, it can sustain higher temperatures once separated from its aluminum substrate after a selective dissolution of the aluminum substrate. This additional step requires the use of mercury chloride, or the like, which introduces safety concerns, adds to the production time and costs and further limits the large scale application of the currently accepted two-anodization step AAO template production technique.

Also, the freestanding AAO templates obtained with this known technique are very thin and brittle and so have limited handleability, for example as part of a composite electrode. The templates are therefore limited to an area of about a few mm² as this appears to be their limit for being safely manipulated and allowing bonding with other materials.

In Masuda (U.S. Pat. No. 6,139,713), an alternative method of making AAO templates from high purity aluminum (99.99% or more) is proposed. A plurality of recesses are formed on a smooth surface of an aluminum plate to be anodized, and then the aluminum plate is anodized to form a porous anodized alumina film in which the pores are regularly arrayed to have the same interval and array as those of the recesses. The recesses are arranged in a periodical array having the shape of a hexagon in order to produce an AAO template having pores arranged in a hexagonal array. However, this method again requires the use of high purity aluminum which is expensive and the resultant template is limited to pores arranged in a hexagonal array.

Therefore, there is a need for an improved method for producing AAO templates which overcomes or reduces at least some of the above described problems.

### SUMMARY

The embodiments disclosed reduce one or more of the aforesaid difficulties and disadvantages.

From a first aspect, certain embodiments of the invention provide for a method for producing an anodic aluminum oxide template having a plurality of pores arranged unevenly along substantially parallel lines, the method comprising providing a commercial grade aluminum alloy substrate, the substrate having substantially parallel lines formed in at least one surface; and anodizing the commercial grade aluminum alloy substrate to form the anodic oxide template having the plurality of pores arranged unevenly along the substantially parallel lines, preferably the commercial grade aluminium alloy substrate is selected from the group consisting of 6061, 6060, 6063, 1060 and 1100 aluminum, preferably a sheet or foil having a thickness which is equal to or less than 0.8 mm. In certain embodiments of the disclosed method, at least some of the lines formed in the at least one surface of the commercial grade aluminum alloy substrate advantageously have depths ranging from about 10 nm to about 30 nm and spacing ranging from about 60 nm to about 100 nm.

In certain embodiments of the disclosed method, the step of providing the substrate optionally further comprises trimming a thicker sample of the commercial grade aluminium alloy to a required size and shape and forming the substantially parallel lines on the at least one surface. Alternatively, the step of providing the substrate comprises trimming a larger sample of the commercial grade aluminium alloy to a required size and shape including orienting the substantially parallel lines in the preferred future orientation of the pore lines in the said aluminum oxide template.

In certain embodiments of the disclosed method, the anodization step preferably comprises placing the substrate in an acid solution bath and applying a voltage of about 5 V to about 300 V, preferably about 40V, for a time of about 1 hour to about 24 hours, preferably 4 hours, at a temperature of about 20-25° C., preferably the acid solution is selected from the group consisting of oxalic acid, phosphoric acid and sulphuric acid, and is preferably oxalic acid.

Certain embodiments of the disclosed method also advantageously further comprises growing carbon nanotubes in the pores of the anodic aluminum oxide template while the aluminium substrate of the template is intact, preferably by exposing the anodic aluminium oxide templates to a hydrocarbon gas at temperatures ranging from about 450 to about 700° C., for about 0.5 to about 4 hours, preferably the hydrocarbon gas is acetylene diluted by hydrogen, and the flow rate of hydrogen is preferably greater or equal to the flow rate of acetylene.

Advantageously, certain embodiments of the disclosed method further comprise depositing catalyst particles into the pores of the anodic aluminum oxide template prior to exposure to said hydrocarbon gas wherein the catalyst particles are selected from a group consisting of cobalt, nickel, cobalt/nickel alloys, iron, cobalt/iron alloys, copper, iron/copper alloys, platinum, molybdenum and iron/molybdenum alloys.

Certain embodiments of the disclosed method further comprise cooling the anodic aluminium oxide template to about 450 to 500° C. at a rate of about 50° C. per hour and maintaining at this temperature range for up to about 36 hours in an inert gas flow. Embodiments of the disclosed method may further comprise cutting the grown carbon nanotubes to the required length.

In another aspect, certain embodiments of the disclosed invention provide an anodic aluminum oxide template comprising a plurality of pores arranged unevenly along substantially parallel lines extending across a surface of the anodic aluminum oxide template, preferably each pore has a diameter of about 40 to about 50 nm and the pores are spaced about 20 nm to about 100 nm apart from each adjacent pore along each line. Preferably the anodic aluminium oxide template is made from a commercial grade aluminum alloy.

In another aspect, certain embodiments of the disclosed invention provide an ordered carbon nanotube array comprising carbon nanotubes extending from pores of an anodic aluminum oxide template according to the invention and in which the aluminum substrate is intact.

Certain embodiments of the disclosed invention provide simplified and less costly approaches to making AAO templates, suitable for CNT growth as well as other applications. An embodiment of the disclosed method of the present invention for making AAO templates requires only a single anodization step, compared to the conventional two-step anodization process. The single anodization step can be undertaken in about 4 hours so is shorter than the conventional two-step anodization process. Furthermore, certain of the disclosed methods of the present invention do not require the use of ultra-high and high purity aluminum and a commercial grade aluminum alloy can be used which reduces costs significantly. The resultant AAO templates have pores arranged along substantially parallel lines, in a non hexagonal ordered array. Finally, the need to separate the AAO template from the aluminum substrate in order to grow CNT arrays is eliminated by using embodiments of the present invention. The resultant AAO templates can sustain CNT growth where the temperature exceeds the softening point of aluminum or its melting point as the aluminum layer is preserved. This achievement was considered so far a practical impossibility. This also makes embodiments of the disclosed AAO templates easier to handle as they are larger. By means of embodiments of the invention, CNTs can be grown by thermal chemical vapour deposition (CVD) without breaking the AAO templates.

Embodiments of the disclosed invention are counter to the current trends in producing AAO templates as a commercial grade aluminium alloy is used which cannot be used with the conventional methods. Also, the resultant AAO templates surprisingly have pores arranged unevenly along substantially parallel lines. This is in contrast to the conventional AAO templates produced by anodization of high purity aluminum which all have hexagonal arrays of pores.

Surprisingly, the Applicants have found that the machining or processing lines present on commercial grade aluminium alloys eliminates the need to pre-form recesses or indents on the aluminum substrate surface. Therefore, a single, short anodization step can be used on commercial grade aluminum alloys. Furthermore, by using commercial grade aluminum alloys with machining lines visible with the naked eye, it is possible to decide in advance the direction along which the pores will be aligned.

In summary, embodiments of the present invention pertain to a method for producing ordered anodic aluminum oxide templates from commercial grade aluminum alloys that are suitable for carbon nanotube growth directly on said as-anodized templates, and to the products produced thereof. These ordered templates offer a faster, cost-effective alternative to AAO templates with hexagonally ordered pores produced from high and ultra-high purity aluminum substrates. The number of steps to produce the templates is limited to a single anodization for commercial grade aluminum alloys. These ordered carbon nanotube arrays can be used as passive catalyst nanoparticle supports or as highly efficient and durable electron emitters to induce light emission in flat panel displays and X-ray sources as well as in research and industrial plasma sources. Other commercial applications include, but are not limited to, CNT-based catalyst support for hydrogen fuel cells as well as electron sources for field emission displays, medical and industrial X-ray sources, gas discharge tubes, electrical contacts and highly emissive, long-lasting electrodes for research and industrial plasma sources. Any conducting materials can be deposited into the pores to create small size electronic circuits or composites, magnetic data storage, sensors, new electrodes for lithium ion battery applications, and filtering applications.

### BRIEF DESCRIPTION OF THE DRAWINGS

Further aspects and advantages of the present invention will become better understood with reference to the description in association with the following in which:

FIG. 1 is a micrograph of a surface of an AAO template made using an embodiment of the present invention;

FIGS. 2a and 2b are micrographs of CNTs grown in the AAO of FIG. 1 shown at a high and a lower magnification respectively.

### DETAILED DESCRIPTION

Embodiments of the disclosed invention are not limited in application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements. In the drawings, like reference characters designate like or similar parts.

Briefly, an embodiment of the invention comprises a method for producing anodic aluminum templates (AAO) having a linear array of pores, the method comprising providing an aluminum alloy substrate which need not be of high purity, and anodizing the aluminum alloy substrate. Surprisingly, the Applicants have found that using a commercial grade aluminum alloy, such as 6061 aluminum alloy or any other suitable alloy such as 6060, 6063, 1060 and 1100, results in an AAO template comprising a plurality of pores formed therethrough which are aligned unevenly along substantially parallel lines. By commercial grade aluminum alloy is meant an aluminum alloy which has a purity less than that of high purity aluminum, preferably a purity of less than about 99.99%, more preferably less than about 99.9%, more preferably less than about 99.6%, more preferably less than about 99.0%, most preferably a purity of about 95.8 to about 97.2% aluminum as seen in commercial grade 6061 aluminum alloy. The commercial grade aluminum alloy can be a cast or a wrought alloy. These substantially parallel lines may be pre-formed on the aluminum alloy to be anodized by polishing, machining, pressing or the like.

In selecting an appropriate commercial grade aluminum alloy, the melting point of the alloy should be considered as well as its magnesium content. If carbon nanotubes are to be grown in the pores of the resultant AAO template using the thermal CVD method, it has been found that Al 6061, Al 6060 and 6063, can be used. If other methods are used to grow the CNTs using a lower temperature, any aluminum alloy may be used as those with lower purity will no longer melt at the temperatures required to grow the CNTs.

This embodiment is described in relation to producing AAO templates for carbon nanotube growth within the pores using a thermal CVD method to grow the carbon nanotubes. However, it will be appreciated that alternative methods of carbon nanotube growth can be used and that AAO templates produced using embodiments of the present invention can also be used for other applications.

In this embodiment, the aluminum alloy to be anodized is a thin sheet or foil of mirror-like 6061 aluminum alloy which has been roll-pressed. The Applicants have found surprisingly that this material has lines, grooves or channels present on the surfaces, probably from a roll pressing or other processing step in its production, some of which are visible to the naked eye. These lines are of dimensions and spacings suitable for AAO template pore formation and are typically about tens of nanometres deep (about 10 nm to about 30 nm) and are spaced about 60 to about 100 nm apart. Samples of the desired dimensions are formed from the as supplied aluminium sheet by trimming such as by cutting manually or in any other suitable manner. The thickness of the sheet or foil of aluminum alloy 6061 is typically about 0.8 mm or less. However, thicker sheets, rods or plates of commercial grade aluminum may also be used and trimmed to the desired size and shape. In this case, the substantially parallel lines may be re-formed in at least one surface of the trimmed sample by machining, roll pressing or polishing or any other suitable means.

To choose a preferred orientation for the lines of pores on the AAO template, the surface of the aluminum alloy sheet is inspected with the naked eye to trim the sample according to some of the lines visible on the mirror-like surface. For the particular application of CNT growth, it was found that rectangular coupons having a length A and a width B (A>B) would withstand the thermal stress more adequately if the lines were oriented along the B dimension.

The purpose of the AAO template may not only be to provide a nanostructured template but may also be to form a ceramic shell around the metallic core. In this case, samples are anodized on both sides and the non-anodized aluminum surface is limited to a minimum, or reduced after the anodization step by chemical etching. The required AAO thickness depends on the total sample thickness and for 0.8 mm thick samples a film thickness of 40 to 50 μm has been found to be sufficient.

The anodization step used can be a standard process known in the art for producing AAO templates and so will not be described here in detail. Briefly, the aluminum alloy is placed in an acid bath at a suitable temperature, the acid being selected from sulphuric, oxalic and phosphoric acid, for example. In this embodiment, oxalic acid at a concentration of about 0.1 Mol/L to about 0.6 Mol/L, preferably about 0.2 Mol/L, was used at a temperature of about 20 to about 30° C., preferably about 20 to 25° C. A voltage is applied for a suitable time. The voltage is in a range from about 5 V to about 300 V, preferably about 40V. The time is in a range of about 1 hour to about 24 hours, preferably about 4 hours. If performed in sulfuric acid, the optimal temperature is about 5 to about 10° C. For phosphoric acid, the optimal anodization temperature is about 65° C.

The thickness of the continuous alumina layer (the barrier oxide) at the bottom of the pores contributes to the overall strength of the sample and therefore oxalic acid which produces a thicker barrier oxide is preferred if CNT growth is intended. The ordering of the pores within the substantially parallel lines improves over time and becomes more uniform (60-100 nm) during the first 3-4 hours of anodization. It has been found that optimized pore ordering along the substantially parallel lines of the commercial grade aluminum alloy are achieved for comparable values of voltage and temperature as required by known conventional methods which use high purity aluminum for producing AAO templates having pores in a hexagonal array.

It is known that decreasing the applied voltage slowly at the end of the anodization process reduces the thickness of the barrier oxide. This step was found to be useful in order to deposit catalyst metals during the subsequent CNT growth process. After the anodization period, which is 4 hours in the present embodiment, the voltage is reduced gradually by steps of 1 V every 10 to 30 seconds with a 4 minute interval spent at 25 V. This helps to make the barrier oxide thickness more uniform and the decreasing ramp reduces the barrier oxide thickness to about 50-100 nm. The samples are then rinsed in water and are ready for further processing such as carbon nanotube growth including catalyst deposition. In this case, the barrier oxide thickness is not excessively reduced as it is the case when using a very slow (1 V/1-2 min) voltage ramp. At these stated conditions for anodization in oxalic acid, a 40-50 micron thick AAO template can be achieved in 4 hours.

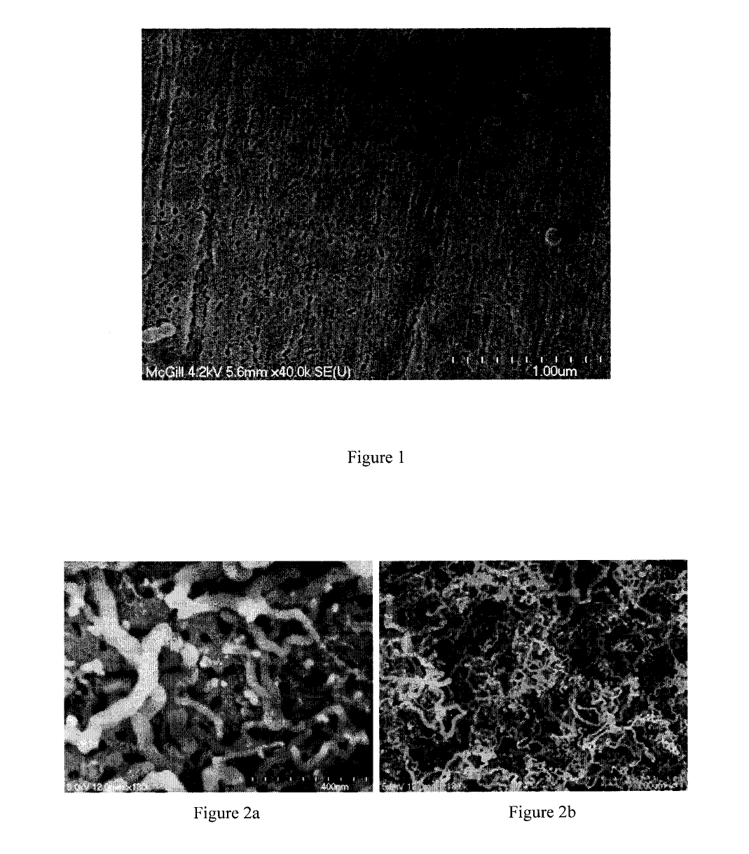

The resultant AAO template has a linearly ordered array of pores of substantially uniform pore diameter. In this embodiment, the pores are aligned unevenly along substantially parallel lines (FIG. 1). By unevenly, it is meant that the pores are not evenly spaced from one another along each of the substantially parallel lines. The pores are not aligned in a hexagonal array. They are ordered in two dimensions only. The pore dimensions are about 40 to 50 nm in diameter. Within a single line, the spacing of the pores from one another varies from about 20 to about 100 nm. In conventionally produced AAO templates using high purity aluminum and the two-step anodization process in oxalic acid, the pore diameters are about 40 to about 50 nm, and the spacing between the hexagonally arranged pores is about 100 nm. Subsequent CNT growth on the resultant AAO templates can be performed by thermal carbon vapour deposition (CVD) in a manner known in the art. The carbon feedstock may be a dried C-containing salt or a liquid filling the pores or a flowing gas such as acetylene. CNT growth in AAO without any metal catalyst can be achieved but faster CNT growth is possible by depositing catalyst particles into the AAO pores by AC (as described in Sang Suh J, Seok Jeong K and Lee J S, 2002, Appl. Phys. Lett., 80 (13), 2392-4), DC plating (as described in Sklar et al, Nanotechnology, 2005, 16, 1265-71) or template wetting (as described in Nerushev et al, 2001, J. Mater. Chem., 11, 1122-32). CNT growth is performed in a carbon source such as a hydrocarbon gas, carbon monoxide, carbon dioxide, evaporating plastics, thermally decomposed metal oxalates and thermally decomposed ethylene glycol hydrogen. In this embodiment, a mixture of acetylene and hydrogen gas was used at temperatures ranging from about 580 to about 700° C. Prolonged sample exposure to hydrogen and high temperatures can cause the AAO to detach from the edges of the metallic substrate. Therefore, the sample should not be exposed to hydrogen at about 700° C. for more than about 4 hours and a period of about 1 hour is sufficient. Because hydrogen is very soluble in liquid aluminum, it is important to avoid cooling the sample in a hydrogen atmosphere. Doing so would cause gaseous hydrogen to precipitate out of the solidifying metal underneath the ceramic layer and break it as a consequence. Injecting an inert gas such as argon or nitrogen prior to the cooling phase for about 30 min is sufficient to let the dissolved hydrogen to diffuse out of the sample. The cooling of the sample must be slow in order to preserve the ceramic film. A cooling rate of about 50° C. per hour is preferred until the sample reaches about 450 to about 500° C. At this point the “natural” cooling rate of a commercial tube furnace once the power is turned off is safe enough to preserve the sample. To improve the CNT quality, the temperature can be maintained above about 500° C. for up to about 36 hours under an inert gas flow. Typically, it was found that a safe range exists below about 600° C. in which the sample will not break and the speed of the CNT graphitization can be increased.

Specifically, the AAO templates are dipped for about 5-10 min in aged (for about 30-48 hours) 50 mMol/L alcohol-based ferric nitrate solution and left to dry. The dried sample is placed on a flat ceramic sample holder in a CVD furnace. After purging the quartz tube with argon, hydrogen gas is injected for about 20 minutes (250 sccm). The temperature is then brought to about 580° C. within about 20 min. After an additional delay of about 5 min, acetylene (C₂H₂) gas is injected for 5-15 min at a flowrate of about 50-130 sccm. Once the injection of acetylene is completed, the hydrogen gas is maintained for about 15-30 min to eliminate amorphous carbon deposits. At this point, argon is injected at a flowrate of about 250 sccm (or more but 250 sccm is typical) and the hydrogen injection is stopped. The temperature is then maintained at about 580° C. for a total of about 25 hours to graphitize the CNT. The temperature is then brought to about 450° C. with a controlled decreasing ramp over about 8-12 hours (typically 10 hours). At 450° C., the furnace is turned off and the argon flow is maintained. Once the temperature has fallen (naturally) below about 60° C., the samples can be retrieved. They are then ready for use or characterization.

Compared to other CNT growth processes such as plasma-enhanced CVD (PECVD) and microwave irradiation-induced synthesis, thermal CVD requires higher substrate temperatures. As a consequence, replacing thermal CVD with either one of these techniques or another allowing the substrate temperature to be reduced can simplify the sample fabrication. Thinner AAO templates are suitable if the underlying aluminum does not melt during CNT growth. Therefore, the duration of the anodization can be less than the 4 hours in oxalic acid in the embodiment described above. It is thought that thinner foils will produce the same ratio between the AAO thickness and the substrate thickness within a shorter time. It is thought that they will be able to sustain the thermal stresses occurring in the CNT growth and cooling phases.

It was found that the very fast CNT growth rate of an embodiment of the present invention created long overgrown CNTs coming out of the pore mouths (FIG. 2). In this case, the CNTs can be trimmed to the required length using an ultrasonic bath in acetone. Trimming the CNT length is optional and is not necessary, for example if the CNTs are to be used as highly emissive electrodes.

It should be appreciated that the invention is not limited to the particular embodiments described and illustrated herein but includes all modifications and variations falling within the scope of the invention as defined in the appended claims.

It should be appreciated that the inventions is not limited to the particular embodiments described and illustrated herein but includes all modifications and variations falling within the scope of the invention as defined in the appended claims.

1. A method for producing an anodic aluminum oxide template having a plurality of pores arranged unevenly along substantially parallel lines, the method comprising:
providing a commercial grade aluminum alloy substrate, the substrate having substantially parallel lines formed in at least one surface; and
anodizing the commercial grade aluminum alloy substrate to form the anodic oxide template having the plurality of pores arranged unevenly along the substantially parallel lines.

2. A method according to claim 1, wherein the commercial grade aluminium alloy substrate is selected from the group consisting of 6061, 6060, 6063, 1060 and 1100 aluminum.

3. A method according to claim 1, wherein at least some of the lines formed in the at least one surface of the commercial grade aluminum alloy substrate have depths ranging from about 10 nm to about 30 nm and spacing ranging from about 60 nm to about 100 nm

4. A method according to claim 1, wherein providing the substrate comprises trimming a thicker sample of the commercial grade aluminium alloy to a required size and shape and forming the substantially parallel lines on the at least one surface.

5. A method according to claim 1, wherein providing the substrate comprises trimming a larger sample of the commercial grade aluminium alloy to a required size and shape including orienting the substantially parallel lines in the preferred future orientation of the pore lines in the said aluminum oxide template.

6. A method according to claim 1, wherein the anodization step comprises placing the substrate in an acid solution bath and applying a voltage of about 5 V to about 300 V, preferably about 40V, for a time of about 1 hour to about 24 hours, preferably 4 hours, at a temperature of about 20-25° C.

7. A method according to claim 6, wherein the acid solution is selected from the group consisting of oxalic acid, phosphoric acid and sulphuric acid, and is preferably oxalic acid.

8. A method according to claim 1, wherein the commercial grade aluminum alloy substrate is a sheet or foil having a thickness which is equal to or less than 0.8 mm.

9. A method according to claim 1, further comprising growing carbon nanotubes in the pores of the anodic aluminum oxide template while the aluminium substrate of the template is intact.

10. A method according to claim 9, wherein growing the carbon nanotubes comprises exposing the anodic aluminium oxide templates to a hydrocarbon gas at temperatures ranging from about 450 to about 700° C., for about 0.5 to about 4 hours.

11. A method according to claim 9, further comprising depositing catalyst particles into the pores of the anodic aluminum oxide template prior to exposure to said hydrocarbon gas wherein the catalyst particles are selected from a group consisting of cobalt, nickel, cobalt/nickel alloys, iron, cobalt/iron alloys, copper, iron/copper alloys, platinum, molybdenum and iron/molybdenum alloys.

12. A method according to claim 9, further comprising cooling the anodic aluminium oxide template to about 450 to 500° C. at a rate of about 50° C. per hour and maintaining at this temperature range for up to about 36 hours in an inert gas flow.

13. A method according to claim 9, wherein the hydrocarbon gas is acetylene diluted by hydrogen.

14. A method according to claim 13, wherein the flow rate of hydrogen is greater or equal to the flow rate of acetylene.

15. A method according to claim 9, further comprising cutting the grown carbon nanotubes to the required length.

16. An anodic aluminum oxide template comprising a plurality of pores arranged unevenly along substantially parallel lines extending across a surface of the anodic aluminum oxide template.

17. An anodic aluminium oxide template according to claim 16, wherein each pore has a diameter of about 40 to about 50 nm and the pores are spaced about 20 nm to about 100 nm apart from each adjacent pore along each line.

18. An anodic aluminium oxide template according to claim 16, made from a commercial grade aluminum alloy.

19. An ordered carbon nanotube array comprising carbon nanotubes extending from pores of an anodic aluminum oxide template according to claim 16 and in which the aluminum substrate is intact.
